(19) United States
(12) Patent Application Publication
(10) Pub. No.: US 2025/0266865 A1
(43) Pub. Date: Aug. 21, 2025

(54) INTELLIGENT REFLECTING SURFACE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP); Hiromi MATSUNO, Fujimino-shi (JP); Takuya OHTO, Fujimino-shi (JP); Yoshiaki AMANO, Fujimino-shi (JP)

(73) Assignee: Japan Display Inc., Tokyo (JP)

(21) Appl. No.: 19/200,777

(22) Filed: May 7, 2025

Related U.S. Application Data
(63) Continuation of application No. PCT/JP2023/032097, filed on Sep. 1, 2023.

(30) Foreign Application Priority Data
Nov. 9, 2022 (JP) 2022-179362

(51) Int. Cl. H04B 7/04; H01Q 15/14; H01Q 21/06

(52) U.S. Cl. CPC H04B 7/04013; H01Q 15/14; H01Q 21/065

(57) ABSTRACT

An intelligent reflecting surface includes a first patch electrode; a second patch electrode adjacent to the first patch electrode; a third patch electrode adjacent to the first patch electrode; a fourth patch electrode adjacent to the second patch electrode and the third patch electrode; a common electrode facing the first patch electrode and the second patch electrode; a liquid crystal layer between the first patch electrode and the second patch electrode and the common electrode, and a first wiring between the first patch electrode and the second patch electrode, wherein an area of the first patch electrode is different from an area of the second patch electrode and the third patch electrode, and a distance between the first patch electrode and the first wiring is equal to a distance between the second patch electrode and the first wiring.

### CROSS-REFERENCE TO RELATED APPLICATIONS

This application is a Continuation of International Patent Application No. PCT/JP2023/032097, filed on Sep. 1, 2023, which claims the benefit of priority to Japanese Patent Application No. 2022-179362, filed on Nov. 9, 2022, the entire contents of each are incorporated herein by reference.

### FIELD

The present invention relates to an intelligent reflecting surface.

### BACKGROUND

A phased array antenna device controls the directivity of an antenna in a fixed state by adjusting the amplitude and phase of a high-frequency signal applied to each of a plurality of antenna elements arranged in a plane. A phased array antenna device requires a phase shifter. The phased array antenna device using a phase shifter that utilizes a change in a dielectric constant due to the orientation state of a liquid crystal is disclosed (for example, refer to Japanese laid-open patent publication No. H11-103201 and Japanese laid-open patent publication No. 2019-530387).

A radio wave reflector, such as a phased array antenna device, which uses a radio wave reflector that can control the reflection direction using a liquid crystal, can control the reflection direction in any direction depending on the voltage applied to the liquid crystal. In the expansion of the 5th generation mobile communication system (5G), it is necessary to further expand the amount of phase change in the reflection phase. In expanding the amount of phase change in the reflection phase, it is difficult to control the voltage applied to the liquid crystal, and there is a need to increase the desired reflection intensity.

### SUMMARY

An intelligent reflecting surface in an embodiment according to the present invention includes a first patch electrode, a second patch electrode adjacent to the first patch electrode, a third patch electrode adjacent to the first patch electrode, a fourth patch electrode adjacent to the second patch electrode and the third patch electrode, a common electrode facing the first patch electrode and the second patch electrode, a liquid crystal layer between the first patch electrode and the second patch electrode and the common electrode, and a first wiring between the first patch electrode and the second patch electrode, wherein an area of the first patch electrode is different from an area of the second patch electrode and the third patch electrode, and a distance between the first patch electrode and the first wiring is equal to a distance between the second patch electrode and the first wiring.

### BRIEF DESCRIPTION OF DRAWINGS

FIG. 1A is a plan view of a reflecting element utilized in a reflecting device according to an embodiment of the present invention.

FIG. 1B is a cross-sectional view of a reflecting element utilized in a reflecting device according to an embodiment of the present invention.

FIG. 2A is a diagram showing a state in which no voltage is applied between a patch electrode and a common electrode when a reflecting element utilized in a reflecting device according to an embodiment of the present invention operates.

FIG. 2B is a diagram showing a state in which a voltage is applied between a patch electrode and a common electrode when a reflecting element utilized in a reflecting device according to an embodiment of the present invention operates.

FIG. 3 is a schematic diagram showing a change in the traveling direction of a reflected wave by a reflecting device according to an embodiment of the present invention.

FIG. 4 is a diagram showing a structure of a reflecting device according to an embodiment of the present invention.

FIG. 5 is a plan view of a reflecting element utilized in a reflecting device according to an embodiment of the present invention.

FIG. 6 is a cross-sectional view of a reflecting element utilized in a reflecting device according to an embodiment of the present invention.

FIG. 7 is a cross-sectional view of wirings utilized in a reflecting device according to an embodiment of the present invention.

FIG. 8 is a diagram showing a structure of a reflecting device according to an embodiment of the present invention.

FIG. 9 is a plan view of a reflecting element utilized in a reflecting device according to an embodiment of the present invention.

### DESCRIPTION OF EMBODIMENTS

### Background to the Invention

The inventors of the present invention have been developing a method for increasing the amount of phase change in the reflection phase of a reflecting element by applying a voltage of the same potential to the liquid crystal of the reflecting element and making the patch electrodes different in size. During this development, it was found that a decrease in reflection intensity may occur due to the provision of power supply wiring between the patch electrodes. The embodiment of the present invention improves this decrease in reflection intensity.

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect. However, the drawings are only an example and do not limit the interpretation of the present invention. In this specification and each drawing, elements similar to those described previously with respect to previous drawings may be given the same reference sign (or a number followed by a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

As used herein, when the area of one member or area, etc., is “equal” to the area of another member or area, etc., the difference in areas is within 10% of one another, preferably within 5%, and even more preferably within 3%. When the distance between a member and another member, etc. is “equal,” the difference in distance is within 10% of one another, preferably within 5%, and even more preferably within 3%. Furthermore, when the lengths of one member and another member, etc. are “equal”, the difference in lengths between each other is within 10% of the length of one, preferably within 5%, and even more preferably within 3%.

As used herein, a reflecting device (radio wave reflecting device) is also referred to as an IRS (Intelligent Reflecting Surface) or the like.

### [Overall Configuration]

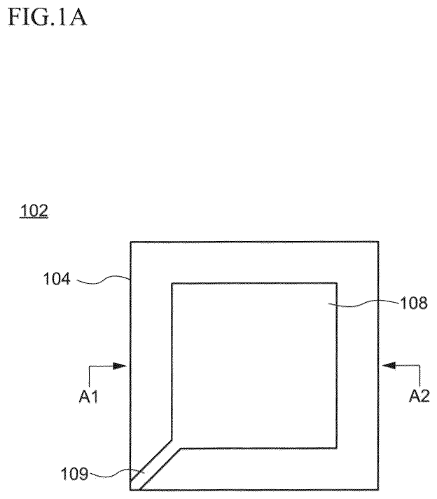

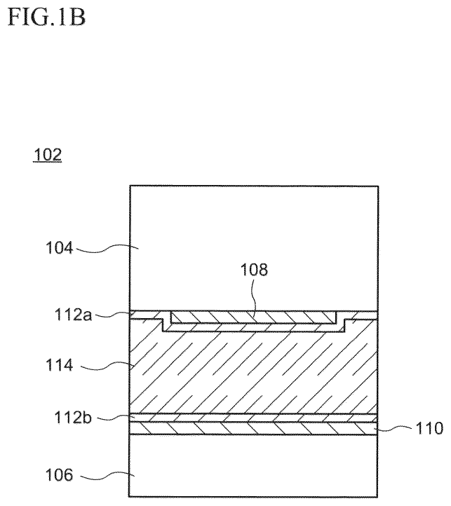

FIG. 1A and FIG. 1B show a reflecting element 102 used in a reflecting device 100 according to an embodiment of the present invention.

### <Reflecting Element>

FIG. 1A shows a plan view of the reflecting element 102 viewed from above (a side where radio waves enter), and FIG. 1B shows a cross-sectional view between A1-A2 shown in a plan view.

As shown in FIG. 1A and FIG. 1B, the reflecting element 102 includes a dielectric substrate 104, a counter substrate 106, a patch electrode 108, a common electrode 110, a first alignment film 112a, a second alignment film 112b, and a liquid crystal layer 114. In the reflecting element 102, the dielectric substrate 104 can be regarded as a dielectric layer as it forms a single layer. The patch electrode 108 is arranged on the dielectric substrate 104, and the common electrode 110 is arranged on the counter substrate 106. The common electrode 110 is disposed on the back side of the patch electrode 108. The first alignment film 112a is arranged on the dielectric substrate (dielectric layer) 104 to cover the patch electrode 108, and the second alignment film 112b is arranged on the counter substrate 106 to cover the common electrode 110. The patch electrode 108 and the common electrode 110 are arranged to face each other, and the liquid crystal layer 114 is sandwiched between the patch electrode 108 and the common electrode 110. The first alignment film 112a is arranged on the dielectric substrate 104 between the patch electrode 108 and the liquid crystal layer 114, and the second alignment film 112b is arranged on the counter substrate 106 between the common electrode 110 and the liquid crystal layer 114.

The patch electrode 108 is preferably symmetrical with respect to the vertical and horizontal polarization of the incoming radio wave, and has a square or rectangle shape in a plan view. When a plurality of patch electrodes 108 are arranged, adjacent patch electrodes 108 differ from each other in area, shape, or orientation of arrangement. FIG. 1A shows the case where the patch electrode 108 has a square shape when seen in a plan view. There is no particular limitation to the shape of the common electrode 110 and it may have a shape in which almost the entire surface of the counter substrate 106 widens to have an area wider than the patch electrode 108. There is no limitation on materials used to form the patch electrode 108 and the common electrode 110, which may be formed using conductive metals and metal oxides. The dielectric substrate (dielectric layer) 104 may have a connection wiring 109. The connection wiring 109 is connected to the patch electrode 108 and can be used to apply a control signal to the patch electrode 108.

Although not shown in FIG. 1A and FIG. 1B, the dielectric substrate (dielectric layer) 104 and the counter substrate 106 are bonded together by a sealant. A distance between the dielectric substrate (dielectric layer) 104 and the counter substrate 106 is 20 to 100 μm, for example, a distance of 50 μm in this case. Since the patch electrode 108, the common electrode 110, the first alignment film 112a, and the second alignment film 112b are disposed between the dielectric substrate (dielectric layer) 104 and the counter substrate 106, the distance between the first alignment film 112a and the second alignment film 112b disposed on each of the dielectric substrate (dielectric layer) 104 and the counter substrate 106 is precisely the thickness of the liquid crystal layer 114. Although not shown in FIG. 1B, a spacer may be disposed between the dielectric substrate (dielectric layer) 104 and the counter substrate 106 to keep the distance constant.

A control signal is applied to the patch electrode 108 to align liquid crystal molecules in the liquid crystal layer 114. The metal electrode 116 is supplied with a potential independent of these signals and is in a floating state. The control signal is a DC voltage signal or a polarity inversion signal in which positive and negative DC voltages are alternately inverted. The common electrode 110 is applied with a voltage at ground or at an intermediate level of the polarity inversion signal. When the control signal is applied to the patch electrode 108, the alignment state of the liquid crystal molecules contained in the liquid crystal layer 114 is changed. Liquid crystal materials having dielectric constant anisotropy are used for the liquid crystal layer 114. For example, nematic, smectic, cholesteric, and discotic liquid crystals are used as the liquid crystal layer 114. The liquid crystal layer 114 with dielectric constant anisotropy has a dielectric constant that changes due to changes in the alignment state of the liquid crystal molecules. The reflecting element 102 can change the dielectric constant of the liquid crystal layer 114 by the control signal applied to the patch electrode 108, thereby delaying the phase of the reflected wave when radio waves are reflected.

The frequency bands of radio waves reflected by the reflecting element 102 are the very short wave (VHF) band, ultra short wave (UHF) band, microwave (SHF) band, submillimeter wave (THF), and millimeter wave (EHF) band. Although the liquid crystal molecules in the liquid crystal layer 114 align themselves in response to the control signal applied to the patch electrode 108, they hardly follow the frequency of the radio waves irradiated to the patch electrode 108. Therefore, the reflecting element 102 can control the phase of the reflected radio waves without being affected by radio waves.

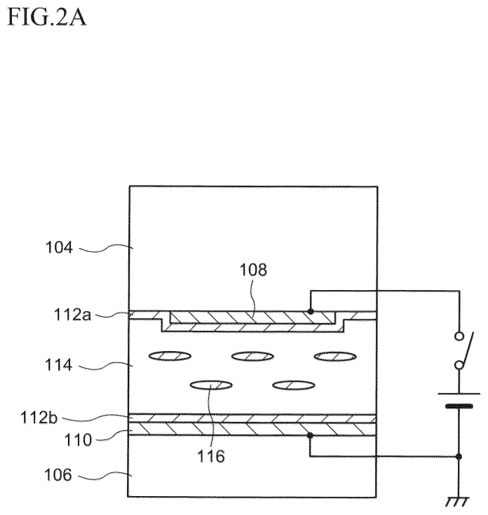

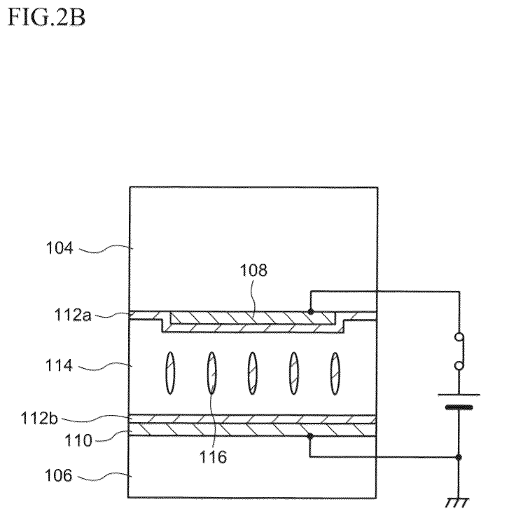

FIG. 2A shows a state (“first state”) in which a voltage is not applied between the patch electrode 108 and the common electrode 110. FIG. 2A shows an example where the first alignment film 112a and the second alignment film 112b are horizontally aligned films. The long axis of the liquid crystal molecules 116 in the first state is aligned horizontally with respect to the surfaces of the patch electrode 108 and the common electrode 110 by the first alignment film 112a and the second alignment film 112b. FIG. 2B shows a state (“second state”) in which a control signal (voltage signal) is applied to the patch electrode 108. The liquid crystal molecules 116 are aligned in the second state with the long axis perpendicular to the surfaces of the patch electrode 108 and the common electrode 110 under the effect of the electric field. According to the magnitude of the control signal applied to the patch electrode 108 (magnitude of the voltage between the counter electrode and the patch electrode), it is possible to align the angle at which the long axis of the liquid crystal molecules 116 is aligned in an intermediate direction between the horizontal and vertical directions.

When the liquid crystal molecules 116 have positive dielectric constant anisotropy, the dielectric constant is greater in the second state relative to the first state. When the liquid crystal molecules 116 have negative dielectric constant anisotropy, the dielectric constant is smaller in the second state relative to the first state. The liquid crystal layer 114 having dielectric anisotropy can be regarded as a variable dielectric layer. The reflecting element 102 can be controlled to delay (or not) the phase of the reflected wave by using the dielectric constant anisotropy of the liquid crystal layer 114.

The reflecting element 102 is used for a reflector that reflects radio waves in a specified direction. The reflecting element 102 should attenuate the amplitude of the reflected radio waves as little as possible. As is clear from the structure shown in FIG. 1B, when a radio wave propagating in the air is reflected by the reflecting element 102, the radio wave passes through the dielectric substrate (dielectric layer) 104 twice. The dielectric substrate (dielectric layer) 104 is formed of a dielectric material such as glass or resin, for example.

The reflector can change the direction of travel of the reflected wave by using a plurality of reflecting elements.

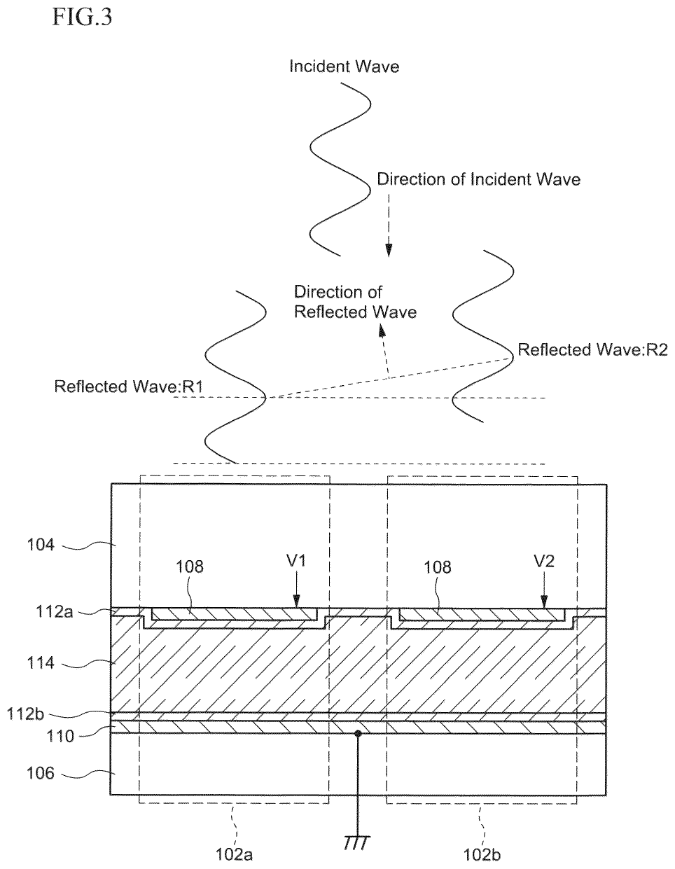

FIG. 3 schematically shows that the direction of travel of the reflected wave is changed by the two reflecting elements 102. In the case where radio waves are incident on the first reflecting element 102a and the second reflecting element 102b at the same phase, since different control signals (V1≠V2) are applied to the first reflecting element 102a and the second reflecting element 102b, the phase change of the reflected wave by the second reflecting element 102b is greater than that of the first reflecting element 102a. As a result, the phase of the reflected wave R1 reflected by the first reflecting element 102a and the phase of the reflected wave R2 reflected by the second reflecting element 102b differ (in FIG. 3, the phase of the reflected wave R2 is more advanced than that of the reflected wave R1), and the apparent traveling direction of the reflected wave changes obliquely.

### <Reflecting Device>

Next, the structure of the reflecting device in which the reflecting elements are integrated is shown.

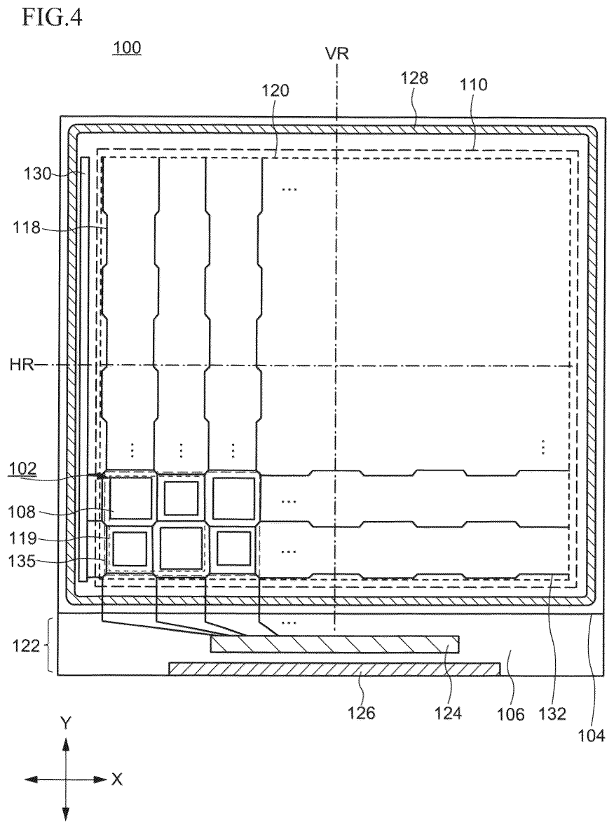

FIG. 4 shows a configuration of a reflecting device 100 according to an embodiment of the present invention. The reflecting device 100 includes a radio wave reflector 120. The radio wave reflector 120 is configured with a plurality of reflecting elements 102. The plurality of reflecting elements 102 are arranged, for example, in a column direction (X-axis direction shown in FIG. 4) and in a row direction (Y-axis direction shown in FIG. 4) that intersects the column direction. The plurality of reflecting elements 102 are arranged so that the patch electrodes 108 face the plane of incidence of radio waves. The radio wave reflector 120 is flat, and the four patch electrodes 108 are arranged on this flat plane as the first pattern 119, and the first pattern 119 is periodically arranged in the row and column directions.

The reflecting device 100 has a structure in which a plurality of reflecting elements 102 are integrated on a single dielectric substrate (dielectric layer) 104. As shown in FIG. 4, the reflecting device 100 has a structure in which the dielectric substrate (dielectric layer) 104 with an array of the plurality of patch electrodes 108 and the counter substrate 106 with the common electrode 110 are arranged on top of each other, and the liquid crystal layer (not shown) is disposed between the two substrates. The radio wave reflector 120 is formed in the region where the plurality of patch electrodes 108 and the common electrode 110 are superimposed. A cross-sectional structure of the radio wave reflector 120 is the same as that of the reflecting element 102 shown in FIG. 1B when viewed with respect to the individual patch electrodes 108. The dielectric substrate (dielectric layer) 104 and the counter substrate 106 are bonded to each other by the sealant 128, and the liquid crystal layer, not shown, is disposed in the region inside the sealant 128.

The dielectric substrate (dielectric layer) 104 has a peripheral area 122 that extends outward from the counter substrate 106 in addition to the area that faces the counter substrate 106. The peripheral region 122 is disposed with a first driver circuit 124, a second drive circuit 130 and a terminal part 126. The first driver circuit 124 outputs control signals to the patch electrode 108. The second drive circuit 130 outputs scanning signals. The terminal part 126 is a region that forms a connection with an external circuit, for example, a connected flexible printed circuit board, not shown in the drawings. Signals controlling the first driver circuit 124 are input to the terminal part 126.

As described above, the plurality of patch electrodes 108 is arranged on the dielectric substrate (dielectric layer) 104 in the first direction (X-axis direction) and the second direction (Y-axis direction). The plurality of patch electrodes 108 in the array differs from adjacent patch electrodes 108 in size from each other, specifically, the adjacent patch electrodes 108 have the same shape but different areas. For example, as shown in FIG. 4, the plurality of patch electrodes 108 are square in shape. One patch electrode 108 adjacent to another patch electrode 108 in the first and second directions has a larger area, while the adjacent patch electrode 108 has a smaller area. Furthermore, in the plurality of patch electrodes 108, another patch electrode 108 located in the diagonal direction of the patch electrode 108 has the same size.

Furthermore, a plurality of first wirings 118 extending in the second direction (Y-axis direction) are arranged in the dielectric substrate (dielectric layer) 104. Each of the plurality of first wirings 118 is electrically connected to the plurality of patch electrodes 108 arranged in the second direction (Y-axis direction) in each row. The radio wave reflector 120 has a configuration of a plurality of single row patch electrode arrays electrically connected by the first wiring 118 in the first direction (X-axis direction).

The plurality of connection wirings 118 arranged on the radio wave reflector 120 extend to the peripheral region 122 and are connected to the first driver circuit 124. The first driver circuit 124 can output control signals of different voltage levels to each of the plurality of connection wirings 118. As a result, the control signal is applied to the plurality of patch electrodes 108 arrayed in the first (X-axis) and second (Y-axis) directions in the radio wave reflector 120, row by row (for each patch electrode 108 arranged in the row direction (Y-axis)).

The plurality of first wires 118 extending to the first drive circuit 124 are arranged at an equal distance between adjacent patch electrodes 108. The plurality of first wirings 118 are positioned so that adjacent patch electrodes 108 are targeted with respect to the first wiring 118. The plurality of first wirings 118 extend to the first driver circuit 124 while bending between the plurality of patch electrodes 108 because of the different areas of adjacent patch electrodes 108. Thus, the first wiring 118 has a plurality of bends between the plurality of patch electrodes 108 in the radio wave reflector 120.

The reflecting device 100 further has a plurality of second wirings 132 extending in the first direction (X-axis direction). The plurality of first wirings 118 and the plurality of second wirings 132 are arranged to intersect across an insulation layer to be described below. The plurality of second wirings 132 are connected to a second driver circuit 130. The second driver circuit 130 outputs scanning signals.

The plurality of second wirings 132 extending to the second driver circuit 130 maintain an even distance between the plurality of patch electrodes 108. The plurality of second wirings 132 are positioned so that adjacent patch electrodes 108 are targeted with respect to the second wiring 132. The plurality of second wirings 132 extend to the second driver circuit 124 while bending between the plurality of patch electrodes 108 because of the different areas of adjacent patch electrodes 108. Thus, the second wiring 132 has a plurality of bends up to the radio wave reflector 120.

The plurality of patch electrodes 108 are each provided with a switching element 134, which is described below. Switching (on and off) of the switching element 134 is controlled by the scanning signal applied to the second wiring 132. A control signal is applied from the connection wiring 109 to the patch electrode 108 where the switching element 134 is turned on. The switching element 134 is formed, for example, by a thin-film transistor. According to this configuration, the plurality of patch electrodes 108 arranged in the first direction (X-axis direction) can be selected row by row, and control signals of different voltage levels can be applied to each row.

The reflecting device 100 can control the direction of travel of the reflected wave in the left and right directions on the drawing, centered on the reflection axis VR parallel to the direction (Y-axis direction), when the radio wave is irradiated on the radio wave reflector 120, and furthermore, the direction of travel of the reflected wave can also be controlled in the vertical direction on the drawing, centered on the reflection axis HR parallel to the first direction (X-axis direction). That is, since the reflecting device 100 has the reflection axis VR parallel to the second direction (Y-axis direction) and the reflection axis HR parallel to the first direction (X-axis direction), the reflection angle can be controlled in the direction with the reflection axis VR as the axis of rotation and in the direction with the reflection axis HR as the axis of rotation.

Such principles can be applied to the radio wave reflector 100 to control the direction of reflection in uniaxial and biaxial directions, for example, by independently controlling the amount of phase change by the reflecting element 102 in both the first and second directional arrays.

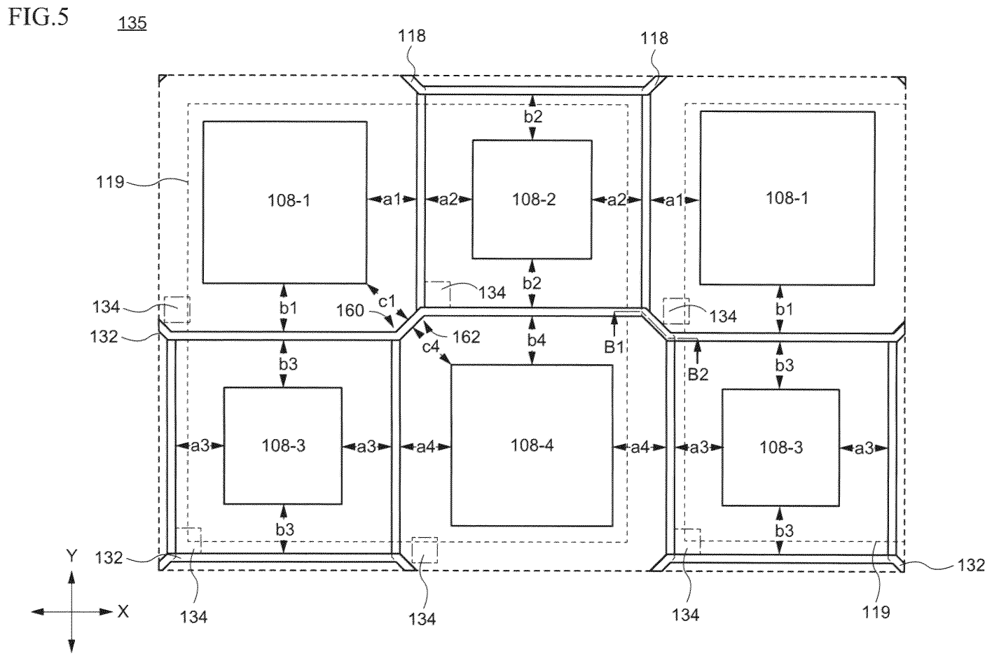

FIG. 5 shows a plan view of the reflecting element 102 shown in FIG. 4. FIG. 5 shows an enlarged view of the first region 135 shown in FIG. 4.

The first region 135 includes a plurality of patch electrodes 108 arranged between the plurality of first wirings 118 and second wirings 132 and a plurality of switching elements 134 that connect to the plurality of patch electrodes 108, respectively.

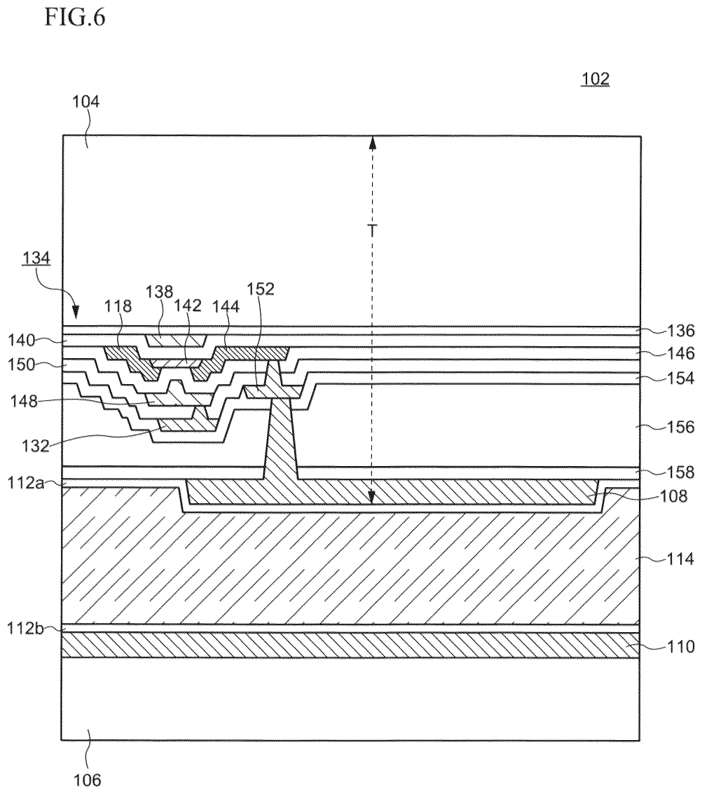

First, a switching element 134 will be described with reference to FIG. 6.

FIG. 6 shows a cross-sectional view of the reflecting element 102. FIG. 6 shows an example of the cross-sectional structure of the reflecting element 102 with the switching element 134 connected to the patch electrode 108. The switching element 134 is disposed on the dielectric substrate (dielectric layer) 104. The switching element 134 is a transistor and has a stacked structure of a first gate electrode 138, a first gate insulating layer 140, a semiconductor layer 142, and a second gate electrode 148. An undercoat layer 136 may be disposed between the first gate electrode 138 and the dielectric substrate (dielectric layer) 104. The first wiring 118 is disposed between the first gate insulating layer 140 and the second gate insulating layer 146. The first wiring 118 is disposed in contact with the semiconductor layer 142. A first connecting wiring 144 is disposed on the same layer as the conductive layer forming the first wiring 118. The first connecting wiring 144 is disposed in contact with the semiconductor layer 142. The connection structure of the first wiring 118 and the first connecting wiring 144 to the semiconductor layer 142 shows a structure in which one wiring is connected to the source of the transistor and the other wiring is connected to the drain. The wiring may be electrically connected to the source or drain of the transistor via conductive connection wiring or electrode pads.

A first interlayer insulating layer 150 is disposed to cover the switching element 134. The second wiring 132 is disposed on the first interlayer insulating layer 150. The second wiring 132 is connected to the second gate electrode 148 through a contact hole formed in the first interlayer insulation layer 150. Although not shown in the figure, the first gate electrode 138 and the second gate electrode 148 are electrically connected to each other in a region that does not overlap the semiconductor layer 142. A second connecting wiring 152 is disposed on the first interlayer insulating layer 150 with the same conductive layer as the second wiring 132. The second connecting wiring 152 is connected to the first connecting wiring 144 through a contact hole formed in the first interlayer insulating layer 150.

A second interlayer insulating layer 154 is disposed to cover the second wiring 132 and the second connecting wiring 152. Furthermore, a planarization layer 156 is disposed to fill the steps of the switching element 134. It is possible to form the patch electrode 108 without being affected by the arrangement of the switching element 134 by arranging the planarization layer 156. A passivation layer 158 is disposed over the flat surface of the planarization layer 156. The patch electrode 108 is disposed over the passivation layer 158. The patch electrode 108 is connected to the second connecting wiring 152 through a contact hole formed through the passivation layer 158, the planarization layer 156, and the second interlayer dielectric layer 154. The first alignment film 112a is disposed over the patch electrode 108.

The counter substrate 106 is provided with the common electrode 110 and the second alignment film 112b, as shown in FIG. 1B. The surface on which the switching element 134 and the patch electrode 108 of the dielectric substrate (dielectric layer) 104 are provided is arranged so that the surface on which the common electrode 110 of the counter substrate 106 is provided faces the surface switching element 134, and the liquid crystal layer 114 is provided between them. A thickness T of the dielectric substrate (dielectric layer) 104 can be the length from the surface of the liquid crystal layer 114 side of the patch electrode 108 to the opposite side of the dielectric substrate (dielectric layer) 104 to the side on which the patch electrode 108 is provided. In this case, the thickness of at least one insulating layer (the undercoat layer 136, the first gate insulating layer 140, the second gate insulating layer 146, the first interlayer insulating layer 150, the second interlayer insulating layer 154, the planarization layer 156, and the passivation layer 158) between the patch electrode 108 and the dielectric substrate (dielectric layer) 104 can be taken into account.

Each layer formed on the dielectric substrate (dielectric layer) 104 is formed using the following materials. The undercoat layer 136 is formed, for example, with a silicon oxide film. The first gate insulating layer 140 and the second gate insulating layer 146 are formed, for example, with a silicon oxide film or a laminated structure of a silicon oxide film and a silicon nitride film. The semiconductor layers are formed of silicon semiconductors such as amorphous silicon and polycrystalline silicon, and oxide semiconductors including metal oxides such as indium oxide, zinc oxide, and gallium oxide. The first gate electrode 138 and the second gate electrode 148 may be configured, for example, of molybdenum (Mo), tungsten (W), or alloys thereof. The first wiring 118, the second wiring 132, the first connecting wiring 144, and the second connecting wiring 152 are formed using metal materials such as titanium (Ti), aluminum (Al), and molybdenum (Mo). For example, a titanium (Ti)/aluminum (Al)/titanium (Ti) laminate structure or a molybdenum (Mo)/aluminum (Al)/molybdenum (Mo) laminate structure may be used. The planarization layer 156 is formed of a resin material such as acrylic, polyimide, or the like. The passivation layer 158 is formed of, for example, a silicon nitride film. The patch electrode 108 and the common electrode 110 are formed of a metal film such as aluminum (Al), copper (Cu), or a transparent conductive film such as indium tin oxide (ITO).

As shown in FIG. 6, it is possible to select and apply a control signal to a predetermined patch electrode 108 from the plurality of patch electrodes 108 arranged in the first and second directions, by connecting the second wiring 132 to the gate of the transistor used as the switching element 134, the first wiring 118 to one of the source and drain of the transistor, and the patch electrode 108 to the other of the source and drain. Then, it is possible to apply a control voltage to each patch electrode 108 arranged in a row along the first direction (x-axis direction) or each patch electrode 108 arranged in a row along the second direction (y-axis direction), by arranging the switching element 134 for each individual patch electrode 108 in the radio wave reflector 120, for example, when the radio wave reflector 120 is upright, and the direction of reflection of the reflected wave can be controlled in the horizontal and vertical directions.

Next, the plurality of patch electrodes 108 connected to the plurality of switching elements 134 are described.

The first region 135 shown in FIG. 5 shows a first pattern 119 that is repeatedly arranged in the first direction and the second direction. The first pattern 119 includes a first patch electrode 108-1, a second patch electrode 108-2, a third patch electrode 108-3, and a fourth patch electrode 108-4.

The first patch electrode 108-1 and the second patch electrode 108-2 are arranged alternately in the first direction, as shown in FIG. 5. The third patch electrode 108-3 and the fourth patch electrode 108-4 are arranged alternately in the first direction, as shown in FIG. 5. The first patch electrode 108-1 and the third patch electrode 108-3 and the second patch electrode 108-2 and the fourth patch electrode 108-4 are arranged alternately in the second direction as shown in FIG. 5. Thus, for example, the second patch electrode 108-2 is arranged to be sandwiched between the two first patch electrodes 108-1 in the first direction and the two fourth patch electrodes 108-4 in the second direction.

The first patch electrode 108-1 is adjacent to the second patch electrode 108-2 and has a different area than the second patch electrode 108-2. The area of the first patch electrode 108-1 is larger than the area of the second patch electrode 108-2. Furthermore, the first patch electrode 108-1 is adjacent to the third patch electrode 108-3 and has a different area than the third patch electrode 108-3. The area of the first patch electrode 108-1 is larger than the area of the third patch electrode 108-3.

The second patch electrode 108-2 is positioned in the diagonal direction of the third patch electrode 108-3, and the area of the second patch electrode 108-2 is equal to the area of the third patch electrode 108-3. Furthermore, the second patch electrode 108-2 is adjacent to the fourth patch electrode 108-4, and the area of the second patch electrode 108-2 is smaller than the area of the fourth patch electrode 108-4.

The third patch electrode 108-3 is adjacent to the fourth patch electrode 108-4, and the area of the third patch electrode 108-3 is smaller than the area of the fourth patch electrode 108-4.

The fourth patch electrode 108-4 is positioned in the diagonal direction of the first patch electrode 108-1, and the area of the fourth patch electrode 108-4 is equal to the area of the first patch electrode 108-1.

One of the first wiring 118 and the second wiring 132 is arranged between each of the first patch electrode 108-1, the second patch electrode 108-2, the third patch electrode 108-3, and the fourth patch electrode 108-4. Specifically, the first wiring 118 is arranged between the first patch electrode 108-1 and the second patch electrode 108-2 and between the third patch electrode 108-3 and the fourth patch electrode 108-4. Further, the second wiring 132 is arranged between the first patch electrode 108-1 and the third patch electrode 108-3 and between the second patch electrode 108-2 and the fourth patch electrode 108-4. Moreover, the second wiring 132 is arranged between the first patch electrode 108-1 and the fourth patch electrode 108-4, and the first wiring 118 is arranged between the second patch electrode 108-2 and the third patch electrode 108-3.

The first wiring 118 is arranged at an equal distance from the first patch electrode 108-1 and the second patch electrode 108-2. Therefore, a distance a1 between the first wiring 118 and the first patch electrode 108-1 is equal to a distance a2 between the first wiring 118 and the second patch electrode 108-2. Further, the first wiring 118 is arranged at an equal distance from the second patch electrode 108-2 and the third patch electrode 108-3. Therefore, the distance a2 between the first wiring 118 and the second patch electrode 108-2 is equal to a distance a3 between the first wiring 118 and the third patch electrode 108-3.

Furthermore, the distance between the first patch electrode 108-1 and the second patch electrode 108-2 is equal to the distance between the third patch electrode 108-3 and the fourth patch electrode 108-4. Thus, the distance a1 and the distance a2 are equal to the distance a3 and the distance a4. The first wiring 118 is arranged at an equal distance between these patch electrodes, so that it has a bend 160 between the first patch electrode 108-1 and the fourth patch electrode 108-4, and between the second patch electrode 108-2 and the third patch electrode 108. The first wiring 118 has a first bend 160, for example, between the nth (n is one or more natural numbers) and n+1st second wiring 132 that intersect the first wiring 118.

The first wiring 118 is also equally arranged at an equal distance from the adjacent patch electrodes in the first bend 160, so that, as shown in FIG. 5, the distance c1 between the first patch electrode 108-1 and the first bend 160 is equal to the distance c4 between the fourth patch electrode 108-4 and the first bend 160.

The second wiring 132 is located at an equal distance from the first patch electrode 108-1 and the third patch electrode 108-3. Therefore, the distance b1 between the second wiring 132 and the first patch electrode 108-1 and the distance b3 between the second wiring 132 and the third patch electrode 108-3 are equal. Further, the second wiring 132 is arranged at an equal distance from the second patch electrode 108-2 and the fourth patch electrode 108-4. Therefore, the distance b2 between the second wiring 132 and the second patch electrode 108-2 and the distance b4 between the second wiring 132 and the fourth patch electrode 108-4 are equal.

Furthermore, the distance between the first patch electrode 108-1 and the third patch electrode 108-3 is equal to the distance between the second patch electrode 108-2 and the fourth patch electrode 108-4. Therefore, the distance b1 and the distance b3 are equal to the distance b2 and the distance b4. The second wiring 132 is arranged at an equal distance between the patch electrodes, and therefore has a second bend 162 between the first patch electrode 108-1 and the third patch electrode and between the second patch electrode 108-2 and the fourth patch electrode 108-4.

The first bend 160 and the second bend 162 described above are parts of the first wiring 118 and the second wiring 132, respectively. Therefore, there is an insulating layer between the first bend 160 and the second bend 162. Here, the insulating layer between the first bend 160 and the second bend 162 will be described with reference to the cross-sectional view along line B1-B2 in FIG. 5.

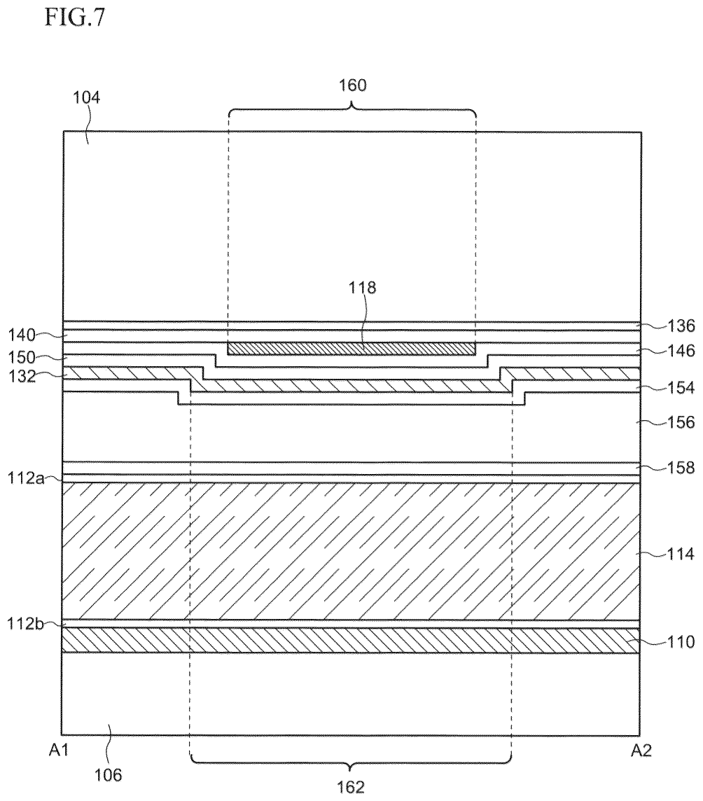

FIG. 7 shows a cross-sectional view of the wiring of the reflecting device 100. FIG. 7 is a cross-sectional view of the first wiring 118 and the wiring 132 between B1 and B2 in FIG. 5.

FIG. 7 shows an example of the cross-sectional structure of the first bend 160 and the second bend 162. The first bend 160 overlaps the second bend 162 in a cross-sectional view. The first bend 160 is a part of the first wiring 118 and therefore has an insulating layer between it and the second bend 162 which is a part of the second wiring 132, for example, the second gate insulating layer 146. In addition, the first bend 160 may have the first interlayer insulating layer 150 between it and the second bend 162.

As described above, the reflecting device 100 according to one embodiment of the present invention has patch electrodes 108 of different sizes arranged adjacent to each other, and the wiring for power supply of the patch electrodes 108 extending between these patch electrodes 108 is arranged at an equal distance from the patch electrodes 108. By arranging the wiring in this manner, the influence of radio waves from each wiring to the patch electrode 108 can be suppressed, and a drop in the reflection amplitude at a certain frequency of the reflecting element 102, which has an expanded variable range for reflecting radio waves by using patch electrodes 108 of different sizes, can be avoided. By avoiding the drop in the reflection amplitude, the reflecting device 100 can achieve a large amount of phase change in the radio waves and further improve the reflection intensity.

### Variations

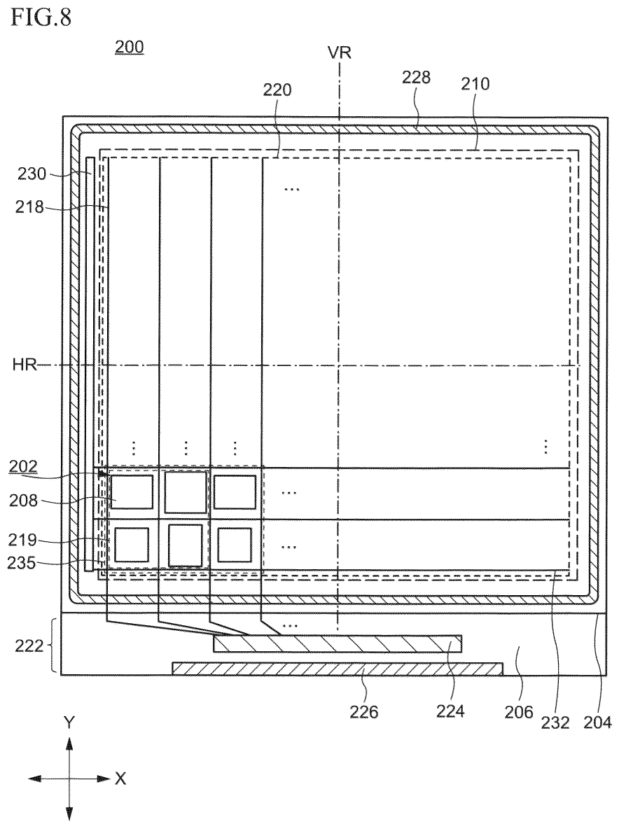

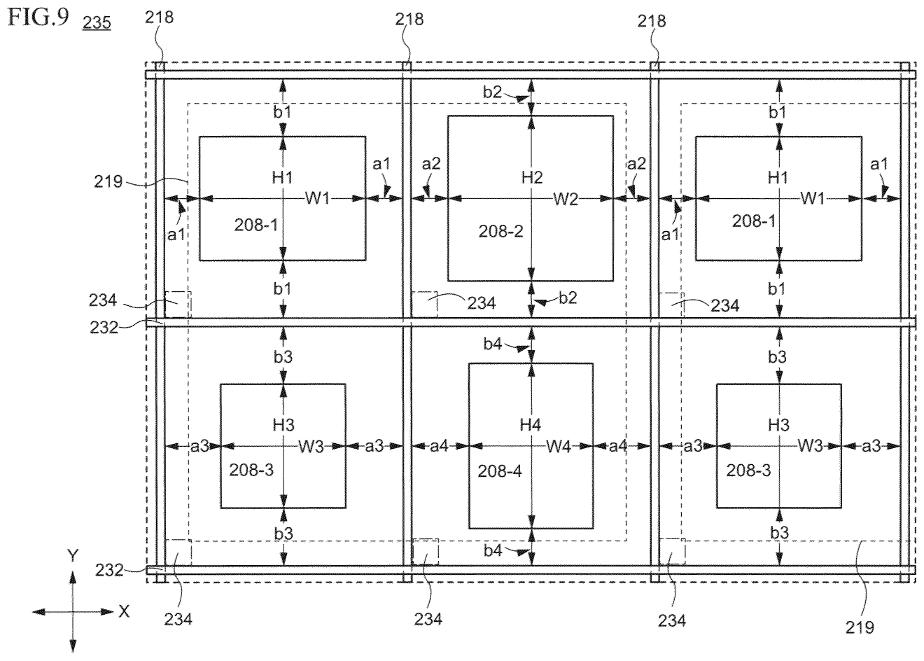

A variation of the reflecting device 200 will be described with reference to FIGS. 8 and 9. The difference from the reflecting device 100 shown in FIGS. 1 to 7 is that four patch electrodes 208 having different sizes or arrangements are repeatedly arranged on the radio wave reflector 220. Furthermore, the difference from the reflecting device 100 shown in FIGS. 1 to 7 is that the first wiring 218 and the second wiring 232 do not have bends between the plurality of patch electrodes 208. It should be noted that the description of configurations that are the same as or similar to the reflecting device 100 shown in FIGS. 1 to 7 may be omitted.

FIG. 8 shows a configuration of the reflecting device 200. FIG. 8 is a plan view of the reflecting device 200. The plurality of patch electrodes 208 arranged in the dielectric substrate (dielectric layer) 204 are square or rectangular in shape. The patch electrodes 208 adjacent to each other in the first direction and the second direction have different shapes and different areas from each other.

The first wiring 218 arranged between the plurality of patch electrodes 208 linearly extends to the first driver circuit 224. Further, the second wiring 232 arranged between the plurality of patch electrodes 208 linearly extends to the second driver circuit 230. The plurality of patch electrodes 208 are arranged so that the distances from the first wiring 218 and the second wiring 232 are uniform. The patch electrodes arranged in this manner are arranged in the first direction and the second direction repeatedly with the four patch electrodes 208 adjacent to each other as the second pattern 219.

Next, a second region 235 including the second pattern 219 and its peripheral structure will be described with reference to FIG. 9. FIG. 9 shows a plan view of the reflecting element 102 shown in FIG. 8. The second region 235 shown in FIG. 9 is an enlarged view of the second region 235 shown in FIG. 8. The second pattern 219 includes a first patch electrode 208-1, a second patch electrode 208-2, a third patch electrode 208-3 and a fourth patch electrode 208-4.

The distance a1 between the first patch electrode 208-1 and the first wiring 218 is equal to the distance a2 between the second patch electrode 208-2 and the first wiring 218. The distance b1 between the first patch electrode 208-1 and the second wiring 232 is equal to the distance b3 between the third patch electrode 208-3 and the second wiring 232. The distance a3 between the third patch electrode 208-3 and the first wiring 218 is equal to the distance a4 between the fourth patch electrode 208-4 and the first wiring 218. The distance b4 between the fourth patch electrode 108-4 and the second wiring 232 is equal to the distance b2 between the second patch electrode 208-2 and the second wiring 232.

The distance a1 and distance a2 are different from the distance a3 and distance a4. Therefore, the distance between the first patch electrode 208-1 and the second patch electrode 208-2 is different to the distance between the third patch electrode 208-3 and the fourth patch electrode 208-4. The distance b1 and distance b3 are different from the distance b2 and distance b4. Therefore, the distance between the first patch electrode 208-1 and the third patch electrode 208-3 is different to the distance between the second patch electrode 208-2 and the fourth patch electrode 208-4.

The first patch electrode 208-1 and the fourth patch electrode 208-4 diagonally opposite thereto are rectangular in shape. The length W1 of the long side of the first patch electrode 208-1 is equal to the length H4 of the short side of the fourth patch electrode 208-4. The length H1 of the short side of the first patch electrode 208-1 is equal to the length H4 of the long side of the fourth patch electrode 208-4. Therefore, the area of the first patch electrode 208-1 is equal to the area of the fourth patch electrode 208-4, and is the same size.

In a plan view, the long axis of the first patch electrode 208-1 is along the second wiring 232, and the long axis of the fourth patch electrode 208-4 is along the first wiring 218. Thus, the first patch electrode 208-1 and the fourth patch electrode 208-4 have the same long and short sides, but are arranged in different directions. Here, the long axis of the first patch electrode 208-1 is defined as the width W1, which is the long side of the first patch electrode 208-1. The long axis of the fourth patch electrode 208-4 is defined as the length H4, which is the long side of the fourth patch electrode 208-4.

The second patch electrode 208-2 and the third patch electrode 208-3 diagonally opposite thereto are square in shape. The length H2 and length W2 of sides of the second patch electrode 208-2 are equal. The length H3 and length W3 of sides of the third patch electrode 208-3 are equal. The area of the second patch electrode 208-2 is different from the area of the third patch electrode 208-3. The area of the second patch electrode 208-2 is larger than the area of the third patch electrode 208-3. Therefore, the length H2 and length W2 of sides of the second patch electrode 208-2 are longer than the length H3 and length W3 of sides of the third patch electrode 208-3.

As described above, the reflecting device 200 according to one embodiment of the present invention has patch electrodes that are square in shape and different sizes, and patch electrodes that are rectangular in shape with the same long and short sides but with the long axes arranged in different directions, and the wiring for power supply of the patch electrodes 208 that extends between these patch electrodes 208 is arranged at an equal distance from the patch electrodes 208. By arranging the wiring in this manner and forming the patch electrodes 208 into rectangles, it is possible to suppress the influence of radio waves from each wiring on the patch electrodes 208, and it is possible to avoid a drop in the reflection amplitude at a certain frequency of the reflecting element 202 that has an expanded variable range for reflecting radio waves by using patch electrodes 208 of different sizes. By avoiding the drop in the reflection amplitude, the reflecting device 200 can achieve a large amount of phase change in radio waves and further improve the reflection intensity.

Each of the embodiments described above as an embodiment of the present invention can be appropriately combined and implemented as long as no contradiction is caused. Further, the addition, deletion, or design change of components, or the addition, deletion, or condition change of processes as appropriate by those skilled in the art based on the display device of each embodiment are also included in the scope of the present invention as long as they are provided with the gist of the present invention.

It is understood that other advantageous effects different from the advantageous effects disposed by the embodiments disclosed herein, which are obvious from the description herein or which can be easily foreseen by a person skilled in the art, will naturally be disposed by the present invention.

### Examples

Next, examples will be described. In the following description, the invention will be described in more detail with examples and specific examples, but the invention is not limited to the following examples.

The present example describes the results of simulating the amplitude (dB) in a radio wave reflector with two different sizes of patch electrodes. As shown in FIG. 9, the simulation assumes a reflector of a radio wave reflector in a state in which the two types of adjacent patch electrodes and the first wiring 218 and second wiring 232 arranged between those patch electrodes are equally spaced between the patch electrodes (implemented example) and a state in which the first and second wiring are not equally spaced between the patch electrodes (comparative example), although not shown in the figure. The size of a patch electrode that is square in shape, e.g., the patch electrode 208-3, is 6.25 mm² which is 2.5 mm by 2.5 mm, and the size of a patch electrode that is rectangular in shape, e.g., the patch electrode 208-4, is 7.00 mm² which is 2.8 mm by 2.5 mm. With the first wiring 218 arranged at equal distances to the patch electrode 208-3 and patch electrode 208-4, the distance between the patch electrodes and the wiring is 1.05 mm. When the wiring is not arranged at an equal distance with respect to the patch electrode, the distance between the patch electrode and the wiring is 0.45 mm and 0.60 mm, respectively. The thickness of the liquid crystal layer 114 of the reflecting element 102a and the reflecting element 102b is 75 μm. The dielectric constant of the liquid crystal layer 114 is from 2.5 ε₀F/m to 3.5 ε₀F/m (ε₀ is the dielectric constant of a vacuum). The dielectric constant is a variable range from no voltage applied to the liquid crystal layer 114 to a variable range of voltage applied to the liquid crystal layer 114. The simulations were performed by CST Studio Suite (Dassault Systèmes, Inc.).

As a result of the simulation, the average reflection amplitude for vertical polarization in the variable dielectric constant range was −7.6 dB for the comparison example and −5.1 dB for the implementation example. The average reflection amplitude for horizontal polarization in the variable dielectric constant range was −5.3 dB in the case of the implemented example compared to −6.4 dB in the comparative example. Therefore, the wiring arrangement in the implemented example was found to be more effective in improving the reflection amplitude by more than 1.1 dB compared to the wiring arrangement in the comparative example.

What is claimed is:

1. An intelligent reflecting surface comprising
a first patch electrode;
a second patch electrode adjacent to the first patch electrode;
a third patch electrode adjacent to the first patch electrode;
a fourth patch electrode adjacent to the second patch electrode and the third patch electrode;
a common electrode facing the first patch electrode and the second patch electrode;
a liquid crystal layer between the first patch electrode and the second patch electrode and the common electrode, and
a first wiring between the first patch electrode and the second patch electrode,
wherein an area of the first patch electrode is different from an area of the second patch electrode and the third patch electrode, and
a distance between the first patch electrode and the first wiring is equal to a distance between the second patch electrode and the first wiring.

2. The intelligent reflecting surface according to claim 1,
wherein the first wiring has a first bend.

3. The intelligent reflecting surface according to claim 2,
wherein the first wiring extends between the third patch electrode and the fourth patch electrode, and
the first bend is arranged between the first patch electrode and the fourth patch electrode.

4. The intelligent reflecting surface according to claim 3,
wherein a distance between the first patch electrode and the first bend is equal to a distance between the fourth patch electrode and the first bend.

5. The intelligent reflecting surface according to claim 1,
wherein an area of the first path electrode is equal to an area of the fourth patch electrode, and
an area of the second patch electrode is equal to an area of the third patch electrode.

6. The intelligent reflecting surface according to claim 3, further comprising,
a second wiring extending between the first patch electrode and the third patch electrode and between the second patch electrode and the fourth patch electrode,
wherein the second wiring has a second bend between the second patch electrode and the third patch electrode.

7. The intelligent reflecting surface according to claim 6, further comprising,
an insulating layer between the first bend and the second bend in a cross-sectional view,
wherein the first bend and the second bend overlap each other.

8. The intelligent reflecting surface according to claim 1, further comprising,
a first switching element electrically connected to the first patch electrode,
wherein the first switching element is electrically connected to the first wiring.

9. The intelligent reflecting surface according to claim 1, further comprising,
a third patch electrode adjacent to the first patch electrode, and
a fourth patch electrode adjacent to the second patch electrode and the third patch electrode,
wherein a distance between the third patch electrode and the first wiring is equal to a distance between the fourth patch electrode and the first wiring, and
an area of the second patch electrode is different from an area of the third patch electrode.

10. The intelligent reflecting surface according to claim 9,
wherein a distance between the first patch electrode and the second patch electrode is different from a distance between the third patch electrode and the fourth patch electrode.

11. The intelligent reflecting surface according to claim 9, further comprising,
a second wiring extending between the first patch electrode and the third patch electrode and between the second patch electrode and the fourth patch electrode,
wherein a distance between the first patch electrode and the second wiring is equal to a distance between the third patch electrode and the second wiring, and
a distance between the second patch electrode and the second wiring is equal to a distance between the fourth patch electrode and the second wiring.

12. The intelligent reflecting surface according to claim 11,
wherein a distance between the first patch electrode and the third patch electrode is different from a distance between the second patch electrode and the fourth patch electrode.

13. The intelligent reflecting surface according to claim 9,
wherein an area of the first patch electrode is equal to an area of the fourth patch electrode, and
a distance between the first patch electrode and the second patch electrode is equal to a distance between the second patch electrode and the fourth patch electrode.

14. The intelligent reflecting surface according to claim 11,
wherein the first patch electrode and the fourth patch electrode are rectangular in shape,
a long axis of the first patch electrode is along the second wiring, and
a long axis of the fourth patch electrode is along the first wiring.
